(19) United States
(12) Patent Application Publication
(10) Pub. No.: US 2013/0238629 A1
(43) Pub. Date: Sep. 12, 2013

(54) SEARCHING NETWORK CONFIGURATION DATA

(71) Applicants: Ram Kumar Kosuri, Fort Collins, CO (US); Swamy Jagannadha Mandavilli, Fort Collins, CO (US); Murali Mohan Dingari, Bothell, WA (US)

(72) Inventors: Ram Kumar Kosuri, Fort Collins, CO (US); Swamy Jagannadha Mandavilli, Fort Collins, CO (US); Murali Mohan Dingari, Bothell, WA (US)

(21) Appl. No.: 13/415,590

(22) Filed: Mar. 8, 2012

(51) Int. Cl. G06F 17/30

(52) U.S. Cl. 707/741; 707/E17.002; 707/E17.005

(57) ABSTRACT

A programmed hardware network configuration file repository indexer is configured with a network-configuration-specific index-operation rule set. In another example, a network-configuration-specific index-operation rule set can be used in generating an index to a network configuration file repository. In the latter example, the index and the index-operation rule set is used in searching the network configuration file repository.

### BACKGROUND

Managing a large computer network, e.g., a data center, can involve keeping track of the configurations of end-node devices, e.g., servers and other computers, storage devices, printers, etc., and infrastructure devices, e.g., routers, switches, access points, and firewalls. In some cases, it may be desirable or even mandatory to maintain not only current configurations, but also configuration change histories.

So that historical and current configuration data is readily accessible even when the corresponding device is shutdown or otherwise unavailable, the configuration data for network devices can be stored in a configuration data repository in the form of configuration data files for respective devices. Network operators can search a file repository, e.g., using a Structured Query Language (SQL) or text-search tools, e.g., for various reports and audits, for grouping of network devices based on configuration entries, and validating compliance based on configuration entries.

### BRIEF DESCRIPTION OF THE DRAWINGS

The following figures represent examples and not the invention itself.

FIG. 1 is a schematic diagram of a network-configuration management system in accordance with an example.

FIG. 2 is a flow chart of a network-configuration management process in accordance with an example.

FIG. 3 is a schematic diagram of another network-configuration management system in accordance with an example.

FIG. 4 is a flow chart of a network-configuration management process implementable in the context of the system of FIG. 3 and in accordance with an example.

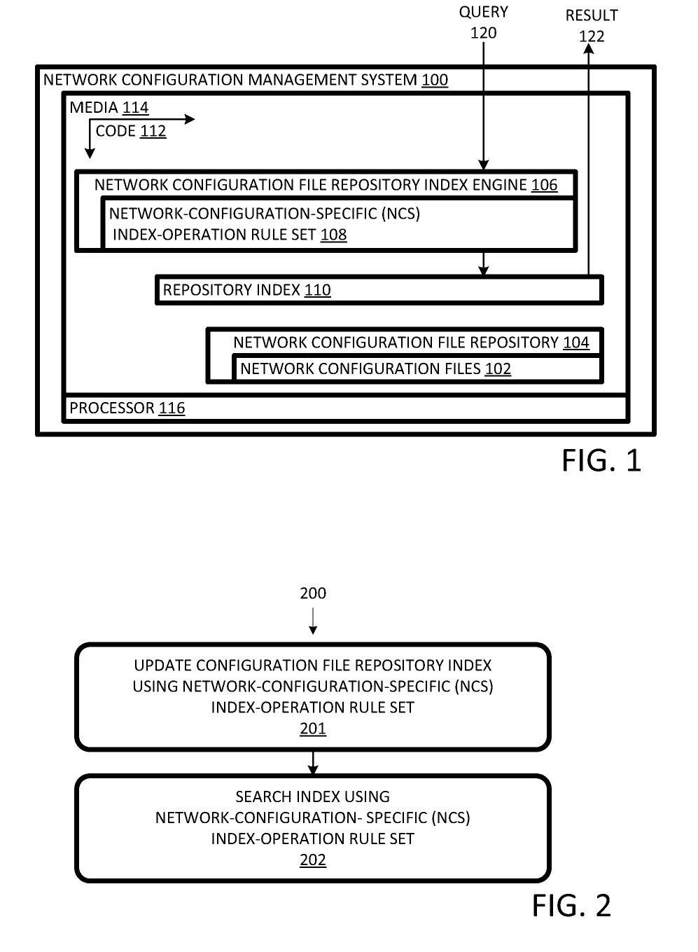

### DETAILED DESCRIPTION

Large computer systems, e.g., data centers, can include hundreds or thousands of managed devices. For example, each infrastructure device can have a unique configuration file containing hundreds of settings, rules, and various other options. Such a configuration file can occupy megabytes of storage. Collectively, the configuration files in a configuration data repository can occupy, for example, tens of gigabytes of storage. In the context of such large amounts of data, search text and SQL queries can be quite slow, e.g. consume minutes or hours to return query results.

A network configuration management system 100 provides for rapid searching of network configuration files 102 in a network-configuration repository 104. To this end, system 100 includes a network-configuration file repository index engine 106 that applies a network-configuration-specific (NCS) index-operation rule set 108 in creating, updating, and/or searching a repository index 110. The functions of index engine 106, index 110, and repository 104 can be define in code 112 encoded in storage media 114 and executed using a processor 116.

A process 200 can be implemented, for example, by executing code 112. At 201, a network configuration file repository index is updated using an NCS index-operation rule set. At 202, the index can be searched, e.g., in response to a query 120, using the NSC index-operation rule set, e.g., to return a result 122. A search that could take minutes or hours using an SQL-type query or text search can be completed in seconds using the index.

Herein, “network-configuration-specific index-operation rule set” or “NCS index-operation rule set” refers to a set of rules to be followed when performing index operations. The index operations can include indexing (crawling) and searching using an index. Thus, an NCS index-operation rule set can include an NCS indexing rule set to be used during indexing and an NCS searching rule set to be used during searching.

Herein, an NCS index-operation rule set is distinguished from a “natural-language index-operation rule set”. Herein, “natural language” refers to a language conventionally used by humans to communicate with each other. For example, English, which may have many variants, is a natural language. An NCS language may be derived from a natural language, typically English, but differ from the source natural language in respects that affect indexing and searching. These differences can be represented in index-operation rule sets used to index and search text.

For example, a natural-language searching rule set might specify that “automobile” is to be searched along with “car” in response to a query specifying only “car”. Such a rule can be omitted from an NCS searching rule set. However, an NCS rule set might include a rule specifying that semantically equivalent Internet Protocol Version 6 (ip6) addresses ‘fe80:0:0:0:202:b3ff:fe1e:8329’ and ‘fe80::202:b3ff:fe1e:8329’ be searched in addition to ‘fe80:0000:0000:0000:0202:b3ff:fe1e:8329’ in response to a query specifying only ‘fe80:0000:0000:0000:0202:b3ff:fe1e:8329’.

A natural-language indexing rule set might specify that a colon (:) is to be treated as a “word breaker” and excluded from a list (implicit or explicit) of “indexable” characters. An NCS indexing rule set might exclude colons from an implicit or explicit list of word breakers and include colons in an implicit or explicit list of indexable characters. Thus, the previously mentioned ip6 addresses would be treated as single words and not be broken down at the colons.

Similarly, a period (.) may be treated as a word breaker in a natural-language indexing set but as an indexable character in an NCS indexing set as it is used in Internet Protocol Version 4 (ip4) addresses. Applying such a rule set by way of example, an natural-language indexer would break the ip4 (Internet protocol version 4) address 10.11.12.13 into four single words 10, 11, 12 and 13. An NCS indexing rule set would leave ip4 addresses intact as they are indexed. Characters such as a space ( ) and a comma (,) may be treated as word breakers in both natural-language and NCS index-operation rule sets.

Furthermore, a natural-language indexing rule set might categorize “a”, “the”, and numbers from 0-9, as noise words and exclude them from an implicit or explicit list of indexable words. A corresponding NCS indexing rule set would specify that the numbers from 0-9 are indexable and exclude them from any list of noise words.

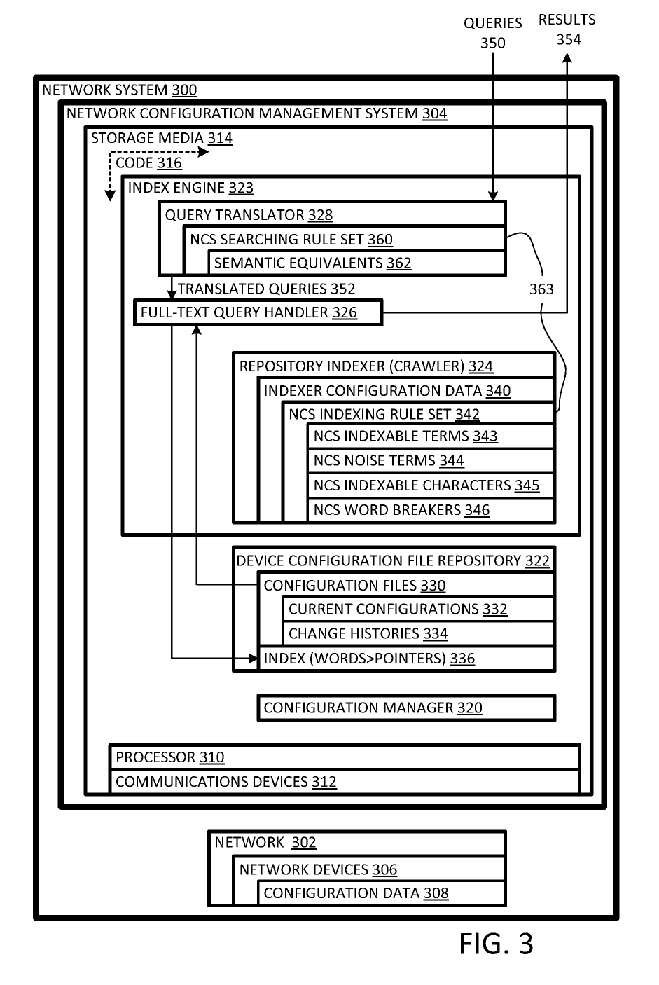

A network system 300, shown in FIG. 3, employs such an NCS index-operation rule set. Network system 300 includes a network 302 and a network configuration management system 304. Depending on the example, a network configuration management system may or may not be a part of the network it manages.

Network 302 includes network devices 306, each of which may include configuration data 308. Network configuration management system 304 includes a processor 310, communications devices 312, and storage media 314. Storage media 314 is encoded with code 316. Code 316 at least in part defines the functionality of network configuration management system 304 and its programmed hardware components including a configuration manager 320, a device configuration repository 322, and an index engine 323 including a repository indexer (crawler) 324, a query handler 326, and a query translator 328. Depending on the example, a network configuration management system may perform network management functions other than network configuration management.

Network devices 306 can include servers and other computers, storage devices (e.g., disk arrays), printers, and network infrastructure devices including routers, switches, access points, and firewalls. For at least some of these network devices, including most of the network infrastructure devices, the functionality is determined in part by configuration data, i.e., parameter (numerical, vector, text-based) values stored on the devices themselves.

Configuration manager 320 manages (i.e., monitors and configures) network 302 in part by tracking and setting configuration data for devices 306. In some cases, e.g., when devices are newly installed, configuration manager 320 polls devices 306 periodically and in response to detected configuration changes. The collected configuration data is stored in device configuration repository 322.

Device configuration file repository 322 stores configuration files 330. Typically, there is one file per device. Files 330 store the current configurations 332 of devices as well as their change histories 334, e.g., a log of all configuration changes, e.g., for the past year (or other period of time).

A network configuration index 336 to network device configuration repository 322 may be stored with repository 322. In an alternative example, the index is separate from the repository. Index 336 is effectively a table of terms (some of which may be phrases) associated with pointers to locations, e.g., corresponding to configuration files and locations within those files. The set of terms indexed is specific to network configuration data, and is determined by repository indexer 324.

Configuration file repository indexer 324 creates and updates index 336 by examining configuration files. This examination can be in the form of “crawling” through the files, typically as a continuous background operation. Indexer 324 has its own configuration data 340. Configuration data 340 defines a network-configuration-specific indexing rule set 342.

Indexing rule set 342 specifies, implicitly or explicitly, a set of indexable terms 343 that are indexable and a set of words that is not indexable; for example, a list of “noise” terms 344 that are to be ignored during indexable are therefore not indexable. The sets of indexable and noise terms differ from corresponding sets for natural languages, such as English. For example, numerical characters may be considered to be indexable NCS terms and not considered noise terms.

Indexing rule set 342 also at least implicitly distinguishes indexable characters 245 and non-indexable characters. For example, in a natural-language indexing rule set, spaces, commas, periods, and colons may be treated as word breakers. However, word breaker set 346 includes periods and colons as indexable characters to accommodate ip4 and ip6 addresses.

Queries to repository 322 are handled by full-text query handler 326. Handler 326 responds to queries by searching index 336 and returning text from files 330 referenced by index pointers. Typically, index-based searches can be performed orders of magnitude faster than text-based and SQL-like character-matching searches can be performed. In some examples, a network-specific query handler can be used. However, in network management system 304, query handler 326 can be a conventional full-text handler. Network-configuration-specific customization is provided by a query translator 328 at the “front end” of handler 326.

Query translator 328 receives queries 350 and translates them according to NCS searching rule set 360 to yield translated queries 352. Collectively NCS indexing rule set 342 and NCS searching rule set 360 constitute an NCS index-operation rule set 363. Results 354 returned by query handler 326 can bypass translator 326. In other examples, results may be passed through or processed by a query translator.

In accordance with NCS searching rule set 360, a single query can be converted into multiple queries including the original but adding semantic equivalents, e.g., as used by different network device manufacturers. To this end, NCS searching rule set 360 specifies network-configuration-specific semantic equivalents 362. For example, if query specifies an ipv6 address, translator 328 outputs not only the address in its original format as specified in a query, but also in other formats. Thus, if the as-received search query is ‘fe80:0000:0000:0000:0202:b3ff:fe1e:8329’, translator 328 adds translated queries for semantic equivalents ‘fe80:0:0:0:202:b3ff:fe1e:8329’ and ‘fe80::202:b3ff:fe1e:8329’.

If a natural-language search tool is used, default semantic equivalents may be excluded and replaced with network-specific semantic equivalents. Likewise, common natural-language search options to use fuzzy matching, e.g., to catch standard and unintentional alternative spellings, may be turned off for use in network-configuration searches. These modification are represented in the NCS index-operation rule set.

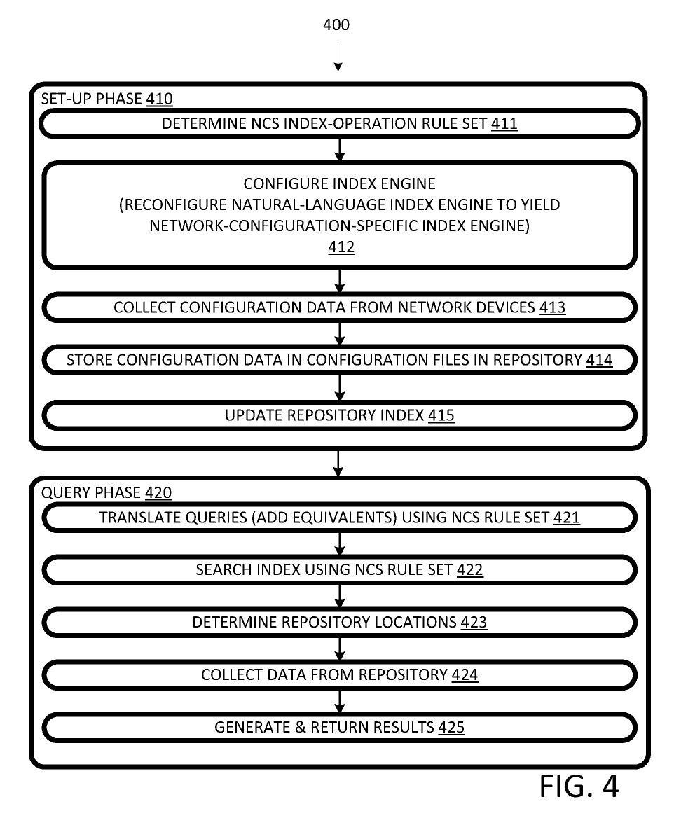

When executed by processor 330, code 316 provides for implementation of a process 400, flow charted in FIG. 4. Process 400 includes a set-up phase 410 and a query phase 420.

Setup phase 410 includes determining network-configuration-specific language indexing and searching rule sets at 411. At 412, an index engine is configured. In practice, a natural-language index engine can be reconfigured to serve as an network-configuration index engine. More specifically, natural-language searching and indexing rules sets can be modified to yield an NCS searching rule set and an NCS indexing rule set. These indexing and searching rule sets can be updated on an ongoing basis, e.g., as new devices and manufacturers are represented in the network being managed. The natural-language index engine used as a starting point or the natural-language indexer and search engine used starting points, can be selected from the variety of available tools used for natural language searching.

At 413, configuration data is collected, e.g., by configuration manager 320, from and regarding network devices. At 414, the configuration data can be stored in files in a network-configuration repository. Storing the data can involve creating new files, e.g., for newly installed devices, and updating old files, e.g., for reconfigured existing devices. In the latter case, a log of configuration changes is maintained, e.g., for as long as the device is installed in the network or for a more limited time. At 415, the repository index is updated, e.g., by an indexer configured with an NCS indexing rule set.

Query phase 420 involves translating original queries according to a NCS searching rule set, e.g., to add NCS equivalents to query terms, at 421. At 422, in response to the translated queries, the repository index is searched; in other words, query terms are matched with index terms. At 423, the associated pointers (and thus the corresponding repository locations, e.g., files and locations within file) are determined. At 424, data is collected from the identified repository locations. At 425, the results are processed and returned, e.g., by query handler 326.

Herein, a “system” is a set of interacting non-transitory tangible elements, wherein the elements can be, by way of example and not of limitation, mechanical components, electrical elements, atoms, physical encodings of instructions, and process actions resulting in or involving a physical transformation.

Herein, a “computer” refers to a hardware machine for physically encoded data in accordance with physically encoded instructions. A “server” is a computer that performs services for other computers. Depending on context, reference to a computer or server may or may not include software installed on the computer. A computer with software installed is “programmed hardware”. Herein, “device” refers to hardware. Herein, unless other apparent from context, a functionally defined component of a computer is a combination of hardware and software executing on that hardware to provide the defined functionality.

Herein, “storage medium” and “storage media” refer to a system including non-transitory tangible material in or on which information is or can be encoded with information including data and instructions. Herein, “processor” refers to hardware for executing instructions. A processor can be a monolithic device, e.g., an integrated circuit, a portion of a device, e.g., core of a multi-core integrated circuit, or a distributed or collocated set of devices. Herein, “communications devices” refers to devices used for communication, including both network devices and devices used for input and output, e.g., human interface devices.

Herein, a network device can include any device arranged to communicate or to handle communications on a computer network. Often, the functionality of network devices can be programmed or set by specifying certain parameter values, typically stored on the device in a text-based configuration file. The language used in such a text-based configuration file is referred to herein as a “network-specific-configuration” language. Rules for indexing and searching such configuration files are referred to as “network-specific-configuration rules”. “Network-specific-configuration rule sets” are sets of one or more such rules that exclude natural-language rules that are not also network-specific configuration rules. Herein, a network-configuration file repository is a storage mechanism for storing copies of network-configuration files together and, for the most part, outside the devices configured using the configuration files.

Herein, a “word breaker” is a character (e.g., a period or colon) or string of characters used by an indexer to distinguish a composite term from a set of separate terms. Herein, a “noise term” is a term (e.g., “a” or “the”) that, when encountered, e.g., during an indexing operation, is to be ignored, e.g., due to lack of semantic importance.

Herein, an “index” is a data structure that, when populated, associates indexed terms with one or more respective locations (e.g., as identified using URLs (Uniform Resource Locators), storage directory paths, file names, and locations within files) in source text at which the terms can be found. A “network-configuration index” is an index to configuration files for network devices. Herein, an “indexer” is, depending on context, programmed hardware or software configured to scan text, identifiable indexable terms, and create and/or update an index based on encountered indexable terms. Herein, “updating an index” encompasses adding, deleting or modifying indexed terms or location associated with an index term in an index.

Herein, “index operation” encompasses creating an index, updating and index, and using an index for searching indexed text. Herein, an “index-operation rule set” can include an indexing rule set used to create or update and index or a searching rule set used when searching using an index or both. A rule set can explicit specify certain characters, words, or phrases, e.g., by listing them in as word breakers, noise words, or semantic equivalents. A rules set can implicitly specify certain characters, words, or phrases, e.g., by omitting them from exclusion lists, e.g., words not listed as noise words are implicitly considered indexable words; likewise, characters not listed as word breakers may be considered parts of indexable words.

In this specification, related art is discussed for expository purposes. Related art labeled “prior art”, if any, is admitted prior art. Related art not labeled “prior art” is not admitted prior art. In the claims, “said” introduces elements for which there is explicit verbatim antecedent basis; “the” introduces elements for which the antecedent basis may be implicit. The illustrated and other described examples, as well as modifications thereto and variations thereupon are within the scope of the following claims.

1. A system comprising:
a configuration manager to track and set configuration data stored on network devices, said configuration data being collected in files in a network-configuration file repository; and
a programmed hardware network-configuration file repository index engine to generate a network-configuration index to said network-configuration file repository, said network-configuration file repository index engine being configured with a network-configuration-specific (NCS) index-operation rule set that includes periods and colons as indexable characters.

2. A system as recited in claim 1 wherein said NCS index-operation rule set excludes periods as word breakers.

3. A system as recited in claim 1 wherein said NCS index-operation rule set includes a set of noise terms that excludes single-digit numbers.

4. A system as recited in claim 1 further comprising a programmed hardware query translator for translating a network configuration query into multiple semantically linguistic queries for submission to a query handler based on said NCS index-operation rule set that specifies semantic equivalents that are not recognized in a natural language.

5. A system as recited in claim 1 further comprising said network-configuration index.

6. A computer-implemented process comprising:
updating a network-configuration file-repository index to a network-configuration file-repository using a network-configuration-specific (NCS) index-operation rule set, said network-configuration file repository containing copies of configuration data stored on a network device and used to configure said network device; and
searching said network-configuration file repository in response to a network configuration query using said NCS index-operation rule set and said network-configuration file-repository index.

7. A process as recited in Claim 6 further comprising:
translating an original query into multiple semantically equivalent queries using a network-configuration-specific index-operation rule set specifying semantic equivalents that are not semantic equivalents in a natural language; and
submitting said multiple semantically equivalent queries to an query handler, said searching including searching said network-configuration file-repository index for each of said multiple semantically equivalent queries defined by said network-configuration-specific index-operation rule set.

8. A process as recited in Claim 7 wherein said multiple semantically equivalent queries express Internet-Protocol (IP) addresses using different formats.

9. A process as recited in Claim 6 wherein said network-configuration-specific indexing rule set that includes periods as indexable characters.

10. A process as recited in Claim 6 wherein said NCS indexing rule set excludes numerical characters as noise terms.

11. A system comprising storage media encoded with code that, when executed by a processor, causes an index engine to translate an original network-configuration query into multiple-semantically equivalent queries according to a network-configuration-specific (NCS) index-operation rule set specifying NCS semantic equivalents that are not semantic equivalents in a natural language.

12. A system as recited in Claim 11 further comprising said processor.

13. A system as recited in Claim 11 further comprising a file repository index engine to index a network-configuration file repository using said NCS index-operation rule set that includes periods and colons as indexable characters.

14. A system as recited in Claim 13 wherein said NCS index-operation rule set excludes periods as word breakers.

15. A system as recited in Claim 13 wherein said NCS index-operation rule set excludes numerical characters as noise terms.
